(19) United States
(12) Patent Application Publication
(10) Pub. No.: US 2016/0109387 A1
(43) Pub. Date: Apr. 21, 2016

(54) IMAGE PROCESSING METHOD, SYSTEM AND APPARATUS

(71) Applicant: CANON KABUSHIKI KAISHA, Tokyo (JP)

(72) Inventor: RUIMIN PAN, Macquarie Park (AU)

(21) Appl. No.: 14/884,570

(22) Filed: Oct. 15, 2015

(30) Foreign Application Priority Data
Oct. 17, 2014 (AU) 2014250719

(51) Int. Cl. G01N 23/04

(52) U.S. Cl. CPC G01N 23/04; G01N 2223/401

(57) ABSTRACT

An image processing method is disclosed. An impulse response of a source of an interferometer system is received. An impulse response of a detector of the interferometer system is received. The source impulse response is determined independently of the detector impulse response. An image of an object generated by a grating of the interferometer system is captured, the image is captured by the detector of the interferometer system. The captured image is processed using the determined detector impulse response to attenuate artefacts introduced by the detector. The processed image is demodulated to produce a demodulated image, artefacts introduced by the source being present in the demodulated image. The demodulated image is processed using the source impulse response to reduce the artefacts in the demodulated image introduced by the source.

### REFERENCE TO RELATED PATENT APPLICATION(S)

This application claims the benefit under 35 U.S.C. §119 of the filing date of Australian Patent Application No. 2014250719, filed 17 Oct. 2014, hereby incorporated by reference in its entirety as if fully set forth herein.

### TECHNICAL FIELD

The current invention relates to resolution enhancement of images captured in an interferometer and, in particular, to an image processing method, system and apparatus. The current invention also relates to a computer program product including a computer readable medium having recorded thereon a computer program for image processing.

### BACKGROUND

Image capture devices project an original scene, natural or artificial, as a projection onto a two-dimensional surface. The two-dimensional projection provides a means for transmitting and analysing information about the original scene. However, capturing an image typically introduces blurring, noise and many other types of degradation.

A digital camera, for example, has limited image resolution depending on a size of sensor pixels. In ultrasound imaging, blurry images result from reflection, refraction and deflection of ultrasound waves from different kinds of tissues as well as the transfer function of an ultrasound acquisition system being utilised. In an interferometer, such as an X-ray Talbot interferometry system, a finite X-ray source size limits spatial resolution of the captured fringe images.

In many imaging systems, blurring is improved using image deconvolution/restoration, where a point spread function (PSF) characterizing the system is estimated or measured. A more general term for point spread function (PSF) is the “impulse response” of the system, the point spread function (PSF) being the impulse response of a focused imaging system.

The estimated or measured point spread function (PSF) may be used to restore an image without blurring caused by the imaging system used to capture the image. For example, image processing methods based on deconvolution with a detector line spread function (LSF) have been used in a free-space propagation X-ray phase contrast imaging (PCI) system in order to improve image resolution. However, line spread function is a very rough estimate of the point spread function of an imaging system and therefore introduces inaccuracy in deconvolved results. Further, the source of blurring in an interferometer such as an X-ray phase contrast imaging (PCI) system is not limited to the detector. Often, blurring is introduced by an X-ray phase contrast imaging (PCI) system, for example, from a finite X-ray source size and optical parts of the system.

Other deblurring methods may be used to address a finite X-ray source size by deconvolving a captured image with a point spread function (PSF) estimated using at least one reference image. Recently, a deconvolution step has been incorporated into a demodulation method of a phase contrast imaging (PCI) system with gratings. An estimated modulation transfer function (MTF) is then used to approximate a real point spread function (PSF). However, methods using such a deconvolution step do not extend well to non-linear systems where a variety of blurring processes occur at different stages.

Deblurring in a phase contrast imaging (PCI) system such as an X-ray Talbot interferometer is difficult due to the often non-linear analysis/demodulation process that is necessary to recover phase information in such an interferometer. A single-shot analysis/demodulation method such as a windowed Fourier transform (WFT) used by a phase contrast imaging (PCI) system often needs to be modified to introduce a certain level of non-linearity to the system in order to address the Heisenberg limit. The Heisenberg limit is an optimal rate at which the accuracy of a measurement can scale with the energy used in the measurement. The dilemma that occurs in a phase contrast imaging (PCI) system is that a narrow window produces undesirable artefacts and a wide window generates low-resolution results. Further, the non-linearity involved in a phase unwrapping step as part of any demodulation method means that any deblurring method which treats deblurring and demodulation as one step will not produce satisfactory results.

Deblurring in a phase contrast imaging (PCI) system such as an X-ray Talbot interferometer is difficult also due to the difficulty in estimating the point spread function (PSF) of the phase contrast imaging (PCI) system. Due to the multiple sources of blurring: finite X-ray source size, limited detector resolution and scintillator point spread function (PSF), representing the blurring with an overall point spread function (PSF) cannot provide accurate results for non-linear phase contrast imaging (PCI) systems. Moreover, currently there are no means for measuring the point spread function (PSF) of each of the blurring sources in phase contrast imaging (PCI) systems individually.

Thus, a need exists for a new image processing method for an interferometer, such as the X-ray Talbot interferometer.

### SUMMARY

It is an object of the present invention to substantially overcome, or at least ameliorate, one or more disadvantages of existing arrangements.

According to one aspect of the present disclosure, there is provided an image processing method comprising:

receiving an impulse response of a source of an interferometer system;

receiving an impulse response of a detector of the interferometer system, the source impulse response being determined independently of the detector impulse response;

capturing an image of an object generated by a grating of the interferometer system, the image being captured by the detector of the interferometer system;

processing the captured image using the determined detector impulse response to attenuate artefacts introduced by the detector;

demodulating the processed image to produce a demodulated image, artefacts introduced by the source being present in the demodulated image; and

processing the demodulated image using the source impulse response to reduce the artefacts in the demodulated image introduced by the source.

According to another aspect of the present disclosure, there is provided an image processing system comprising:

a memory for storing data and a computer program;

a processor coupled to the memory for executing the computer program, said computer program comprising instructions for:
receiving an impulse response of a source of an interferometer system;
receiving an impulse response of a detector of the interferometer system, the source impulse response being determined independently of the detector impulse response;
capturing an image of an object generated by a grating of the interferometer system, the image being captured by the detector of the interferometer system;
processing the captured image using the determined detector impulse response to attenuate artefacts introduced by the detector;
demodulating the processed image to produce a demodulated image, artefacts introduced by the source being present in the demodulated image; and
processing the demodulated image using the source impulse response to reduce the artefacts in the demodulated image introduced by the source.

According to still another aspect of the present disclosure, there is provided an image processing apparatus comprising:

receiving module for receiving an impulse response of a source of an interferometer system and for receiving an impulse response of a detector of the interferometer system, the source impulse response being determined independently of the detector impulse response;

capturing module for capturing an image of an object generated by a grating of the interferometer system, the image being captured by the detector of the interferometer system;

processing module for processing the captured image using the determined detector impulse response to attenuate artefacts introduced by the detector;

demodulating module for demodulating the processed image to produce a demodulated image, artefacts introduced by the source being present in the demodulated image; and

processing module for processing the demodulated image using the source impulse response to reduce the artefacts in the demodulated image introduced by the source.

According to still another aspect of the present disclosure, there is provided a computer readable medium having a computer program recorded thereon for image processing, the program comprising:

code for receiving an impulse response of a source of an interferometer system;

code for receiving an impulse response of a detector of the interferometer system, the source impulse response being determined independently of the detector impulse response;

code for capturing an image of an object generated by a grating of the interferometer system, the image being captured by the detector of the interferometer system;

code for processing the captured image using the determined detector impulse response to attenuate artefacts introduced by the detector;

code for demodulating the processed image to produce a demodulated image, artefacts introduced by the source being present in the demodulated image; and

code for processing the demodulated image using the source impulse response to reduce the artefacts in the demodulated image introduced by the source.

According to still another aspect of the present disclosure, there is provided a method for processing an image of an object captured by a system, the method comprising:

capturing a first image to determine an impulse response of an energy source of the system, the first image being produced by energy waves from the energy source passing through a first opening device of the system, the first opening device being positioned towards the energy source; and

capturing a second image to determine an impulse response of a detector of the system, the second image being produced by the energy waves passing through a second opening device of the system, the second opening device being positioned towards the detector, wherein the source impulse response and the detector impulse response are determined to be used independently to process the image of the object.

According to still another aspect of the present disclosure, there is provided a system for processing an image of an object captured, the system comprising:

a memory for storing data and a computer program; and

a processor coupled to the memory for executing the program, the program comprising instructions for:
capturing a first image to determine an impulse response of an energy source of the system, the first image being produced by energy waves from the energy source passing through a first opening device of the system, the first opening device being positioned towards the energy source; and
capturing a second image to determine an impulse response of a detector of the system, the second image being produced by the energy waves passing through a second opening device of the system, the second opening device being positioned towards the detector, wherein the source impulse response and the detector impulse response are determined to be used independently to process the image of the object.

According to still another aspect of the present disclosure, there is provided an apparatus for processing an image of an object captured by a system, the apparatus comprising:

capturing module for capturing a first image to determine an impulse response of an energy source of the system, the first image being produced by energy waves from the energy source passing through a first opening device of the system, the first opening device being positioned towards the energy source, wherein the capturing module captures a second image to determine an impulse response of a detector of the system, the second image being produced by the energy waves passing through a second opening device of the system, the second opening device being positioned towards the detector; and

processing module for processing the image of the object using the source impulse response and the detector impulse response.

According to still another aspect of the present disclosure, there is provided a computer readable medium having a computer program stored thereon for processing an image of an object captured by a system, the program comprising:

code for capturing a first image of the object to determine an impulse response of an energy source of the system, the first image being produced by energy waves from the energy source passing through a first opening device of the system, the first opening device being positioned towards the energy source;

code for capturing a second image of the object to determine an impulse response of a detector of the system, the second image being produced by the energy waves passing through a second opening device of the system, the second opening device being positioned towards the detector; and

code for processing the image of the object using the source impulse response and the detector impulse response.

According to still another aspect of the present disclosure, there is provided a system comprising:

an x-ray source producing a plurality of X-rays;

a source grating forming a plurality of virtual sources as at least a portion of the X-rays pass through openings in the source grating, the source grating being associated with a source impulse response of the system to at least one of the plurality of virtual sources;

a detector adapted to capture an image from the source grating, the captured image being dependent on at least the source impulse response and characteristics of the detector; and

a processor for executing a computer program, the computer program comprising instructions for:
processing the captured image using the characteristics of the detector to attenuate artefacts introduced by the detector;
demodulating the processed image to determine a demodulated image; and
processing the demodulated image using the source impulse response to enhance contrast in the demodulated image.

Other aspects of the invention are also disclosed.

### BRIEF DESCRIPTION OF THE DRAWINGS

One or more embodiments of the invention will now be described with reference to the following drawings, in which:

FIG. 1 an example X-ray Talbot interferometer system;

FIG. 2A shows an example of a phase grating;

FIG. 2B shows an example of an absorption grating;

FIG. 3 shows the example X-ray Talbot interferometer system of FIG. 1 in more detail;

FIG. 4 is a diagram of the X-ray Talbot interferometer system of FIG. 1 showing the formation of a fringe image;

FIG. 5 shows an example of two fringe images which are combined to form a fringe image with low contrast;

FIG. 6 is a block diagram showing an image processing method;

FIG. 7 is a flow diagram showing a detector deblurring method as executed in FIG. 6;

FIG. 8 is a flow diagram showing a source deblurring method as executed in FIG. 6;

FIG. 9 shows the example X-ray Talbot interferometer system of FIG. 1 configured to measure the point spread function (PSF) of the detector;

FIG. 10 shows an example of a multi-opening device used in detector and source point spread function (PSF) measurement;

FIG. 11 shows the example X-ray Talbot interferometer of FIG. 1 configured to measure the point spread function (PSF) of the source;

FIG. 12 shows a captured point spread function (PSF) image with nine (9) light spots, where the image is divided into several non-overlapping regions;

FIG. 13 shows the captured point spread function (PSF) image of FIG. 12 divided into three non-overlapping regions;

FIG. 14 an example of magnification of object information in the X-ray Talbot interferometer system; and

FIGS. 15A and 15B collectively form a schematic block diagram representation of an electronic device upon which described arrangements can be practised.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

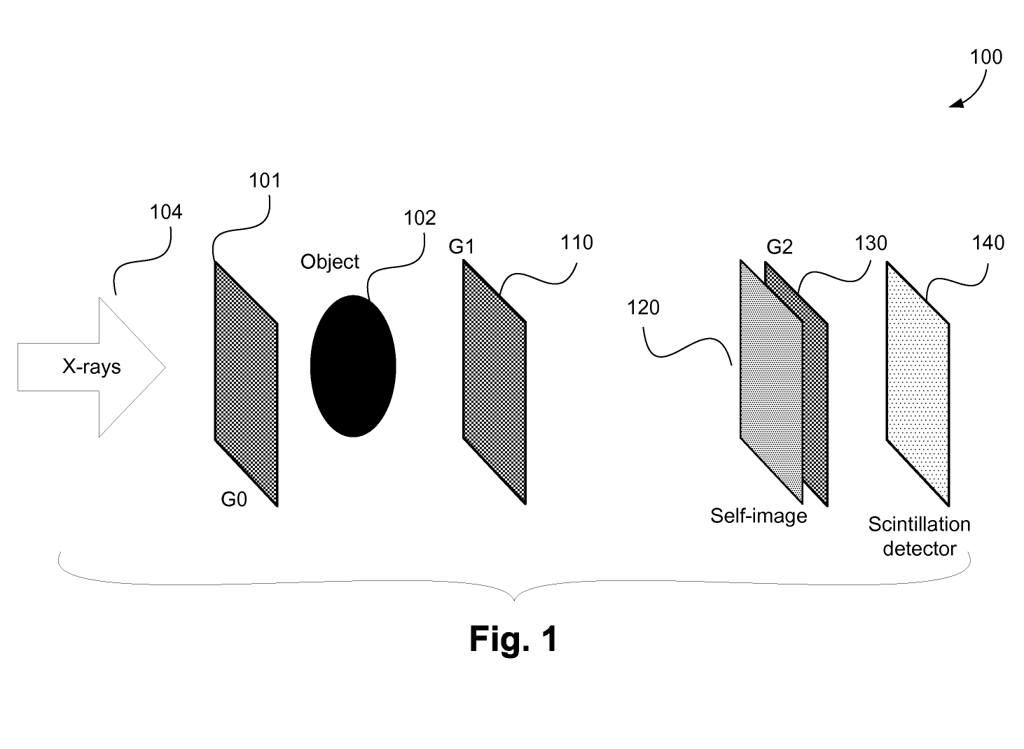

FIG. 1 shows an example of an X-ray Talbot interferometer system 100. The X-ray Talbot interferometer system may also be referred to as an “interferometer”. The X-ray Talbot interferometer system 100 comprises a diffraction device in the form of a source grating G0 101, a diffraction device in the form of a phase grating G1 110 and a diffraction device in the form of a second absorption grating G2 130. The X-ray Talbot interferometer system 100 also comprises a scintillation detector 140. The phase grating G1 110 is positioned between the source grating G0 101 and the scintillation detector 140.

As seen in FIG. 1, the source grating G0 101, an object 102, the phase grating G1 110 and the second absorption grating G2 130 are illuminated by an X-ray source 104 directing energy carried by electromagnetic waves towards the object 102. In the arrangement of FIG. 1, the X-ray source 104 produces a plurality of X-rays and a self-image 120 is formed behind the phase grating G1 110 due to a near-field diffraction effect referred to as the “Talbot effect”. Since the phase of the X-ray waves from the source 104 is shifted by the object 102, the self-image 120 of the phase grating G1 110 is deformed. By analysing the deformed self-image 120, the characteristics of the object 102 can be deduced. The image of the object 102 is produced by the electromagnetic waves (or “energy waves”) from the source 104 passing through the source grating G0 101, the phase grating G1 110, and the absorption grating G2 130 of the system 101. As described in detail below, an image may be captured to determine the point spread function (PSF) of the X-ray source 104 (or “energy source”) of the system 100. The point spread function (PSF) of the X-ray source 104 may also be referred to as the source point spread function. As also mentioned above, a more general term for point spread function (PSF) is the “impulse response”. The source point spread function may also be referred to as the “source impulse response”.

The X-ray Talbot (XT) imaging system 100 described above may be referred to as an “X-ray Talbot (XT) imaging system” which uses phase differences instead of absorption to produce contrast. The resolution of such an X-ray Talbot (XT) imaging system is much higher than a conventional absorption X-ray.

A second image may be captured to determine a point spread function (PSF) of the scintillation detector 140 of the system 100. The point spread function (PSF) of the detector 140 may also be referred to as the “detector point spread function”. The detector point spread function may also be referred to as the “detector impulse response”. As shown in FIG. 1, the second absorption grating G2 130 is positioned towards the detector 140 at the position of the self-image 120. The second absorption grating G2 130 of the interferometer system 100 generates a moiré fringe image, the moiré fringe image being captured by the scintillation detector 140 of the interferometer system 100. The moiré fringe image is a phase contrast image.

Methods are described below for processing the images of the object 102 captured by the interferometer system 100 using the source point spread function (PSF) (or source impulse response) and the detector point spread function (PSF) (or detector impulse response) of the system 100. In one arrangement, the pitch of the second absorption grating G2 130 is similar to that of the projected self-image 120. The moiré fringe image generated by superposing the deformed self-image 120 and the second absorption grating G2 130 gives a much larger version of the self-image 120. The scintillation detector 140 uses the larger version of the self-image 120 to resolve the moiré fringe image. The scintillation detector 140 is an image detector with a scintillator coupled to an electronic light sensor, where the scintillator is used to convert X-ray energy to visible light. In one arrangement, the absorption grating G2 130 and the scintillation detector 140 are placed very close to each other such that the same position is assumed for both the absorption grating G2 130 and the scintillation detector 140 for the purposes of the description below.

In the X-ray Talbot (XT) interferometer system 100 of FIG. 1, the gratings, G0 101, G1 110 and G2 130 may be in the form of thin plates parallel to each other. The surface of the scintillation detector 140 may also be assumed to be parallel to the gratings G0 101, G1 110 and G2 130.

The X-ray Talbot interferometer system 100 shown in FIG. 1 uses the source grating G0 101 for forming a plurality (or “an array”) of virtual point sources. The virtual sources are formed so that a self-image 120 of the phase grating G1 110 can form at a certain Talbot distance from grating G1 110. The virtual sources are formed as at least a portion of the X-rays pass through openings in the source grating G0 101, the source grating G0 101 being associated with a source point spread function (PSF) (or source impulse response) of the system 100 to at least one of the plurality of virtual sources.

The self-image 120 of the phase grating G1 110 has good contrast/visibility even when the X-ray source is relatively large. The pitch p₂ of the absorption grating G2 130 and the pitch p₀ of the source grating G0 101 of the X-ray Talbot (XT) interferometer system 100 of FIG. 1 obey the rule defined by Equation (1), below:

$${p}_{0} = \frac{L}{d} {p}_{2} , \qquad ( 1 )$$

where:

p₀ represents the pitch of the source grating G0 101;

p₂ represents the pitch of the absorption grating G2 130 and the period of the projected self-image 120 of the phase grating G1 110;

L represents the distance between the source grating G0 101 and the phase grating G1 110; and

d represents the distance between the phase grating G1 110 and the absorption grating G2 130.

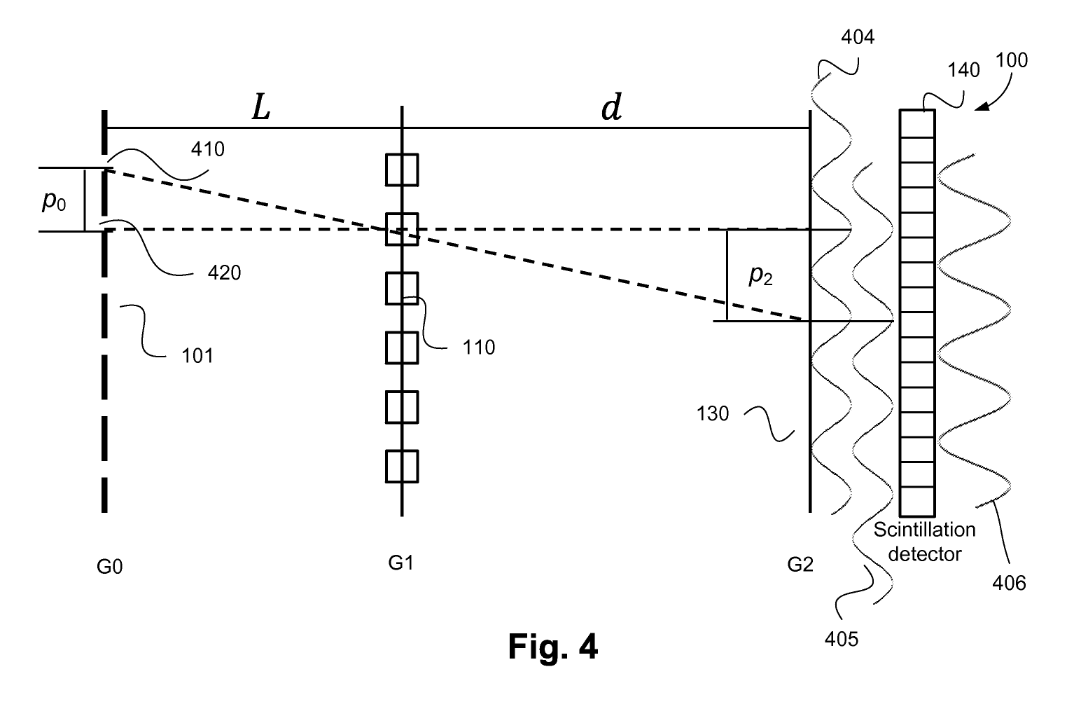

The X-ray Talbot (XT) interferometer system 100 is shown in FIG. 3 in more detail. The relationship between the pitch p₀ of the source grating G0 101 and the pitch p₂ of the absorption grating G2 130, as defined by Equation (1), is also shown in FIG. 3. A representation 310 of a one-dimensional (1D) profile of the X-ray source 104 is represented in FIG. 3. A projected one dimensional (1D) fringe image 360 on the absorption grating G2 is also represented in FIG. 3. In FIG. 3, reference number 305 indicates the period p₂ of the fringe images and reference number 306 indicates the pitch p₀ of the source grating G0 101. The full width at half maximum (FWHM) value, S, of the projected X-ray source profile 307 at the absorption grating G2 130 follows a rule defined by Equation (2), below:

$$S = \frac{L}{d} W , \qquad ( 2 )$$

where:

S: indicated by reference numeral 308, is the full width at half maximum (FWHM) value of the X-ray source profile 310 at the source grating G0 101; and

W: indicated by 309, is the full width at half maximum (FWHM) of the projected X-ray source profile 307 at the absorption grating G2 130.

In the example of FIG. 3, when the object 102 is placed close to phase grating G1 110, magnification M of the object information is determined in accordance with Equation (3), as follows:

$$M = \frac{L + d}{L} \qquad ( 3 )$$

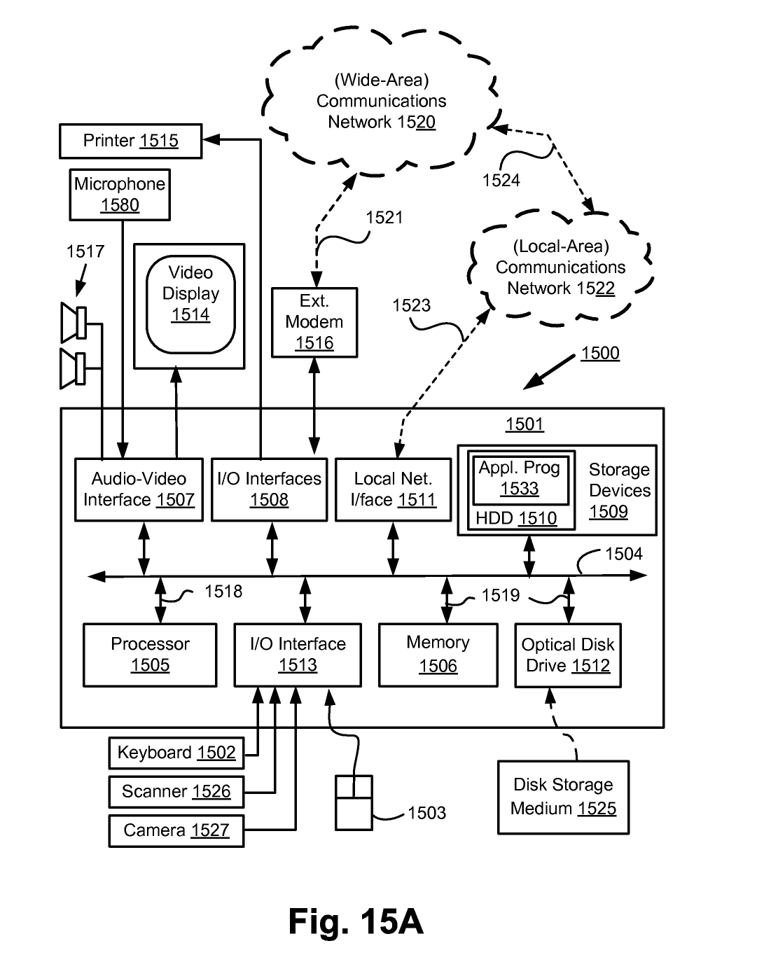

Magnification M of object information will now be described with reference to FIG. 14. When the object 102 is placed adjacent to the phase grating G1 110, the projection of the object 102 from a point source on the source grating G0 101 onto the second absorption grating G2 130 is magnified by M in Equation (3). The ratio Z₂ 1415 over Z₁1405 is

$$\frac{L + d}{L} .$$

One-dimensional gratings may be used in X-ray Talbot systems to simplify phase analysis. However, gratings that use two-dimensional (2D) structures may be used in X-ray Talbot systems to give phase contrast in both x and y directions.

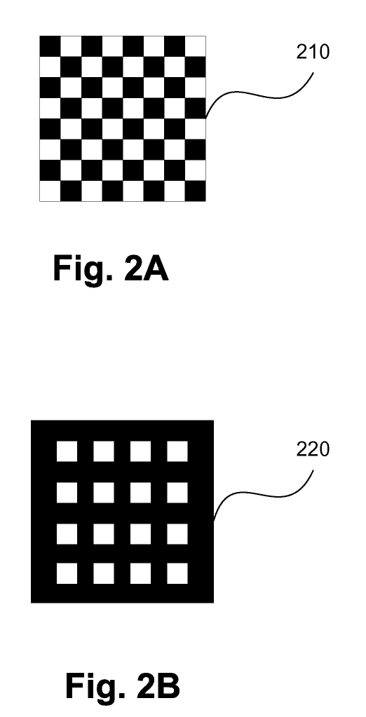

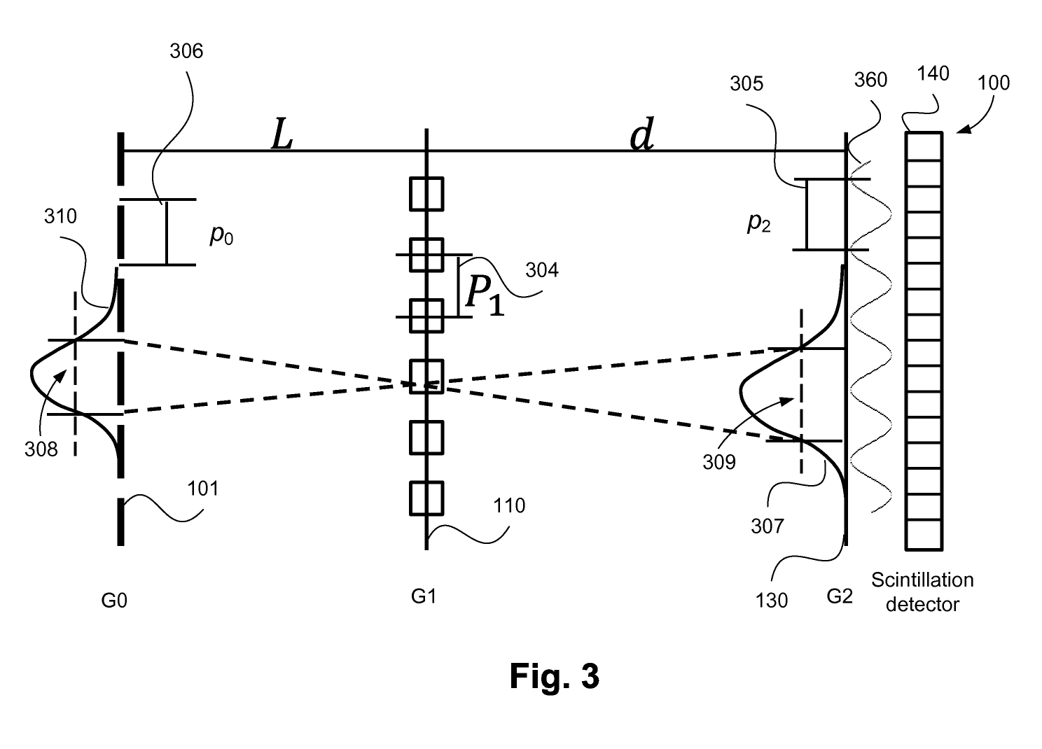

Examples of two-dimensional (2D) gratings are shown in FIGS. 2A and 2B, where grating 210 is an example of the phase grating G1 110. Grating 220 shows an example of the absorption grating G2 130.

As seen in FIG. 2A, for the grating 210, dark areas represent regions on the phase grating G1 110 where a phase shift of π is imposed. The bright areas in FIG. 2A represent regions on the phase grating G1 110 where no phase shift is imposed.

For the grating 220 of FIG. 2B, dark areas represent regions on the absorption grating G2 130 that absorb the X-ray energy of the source 104. Bright areas in the grating 220 shown in FIG. 2B represent regions (or openings) on the absorption grating G2 130 that let the X-ray energy of the source 104 go through.

Methods described below may be implemented using one-dimensional gratings as well as two-dimensional gratings as shown in FIGS. 2A and 2B. However, the methods will be described with reference to one-dimensional grating examples for ease of explanation. As will be described in detail below, the X-ray Talbot (XT) interferometer system 100 is used for capturing an image generated by a grating of the interferometer system 100, the image being captured by a detector 140 of the interferometer system 100.

After the moiré fringe images generated in the X-ray Talbot (XT) interferometer system 100 are captured, phase demodulation and unwrapping are applied to the moiré fringe images so that the phase information of the object 102 can be extracted. Due to the high sensitivity of the X-ray Talbot (XT) interferometer system 100 to refraction and the ability of the interferometer system 100 to produce high-contrast images for soft tissues, application of X-ray Talbot phase contrast imaging (PCI) in medical imaging leads to low dosage and better image resolution, which results in safer and more accurate diagnoses.

Due to finite X-ray source size, optical characteristics and detector point spread function (PSF) (or “detector impulse response”), images captured in an X-ray Talbot (XT) interferometer are often blurry and noisy. While a higher quality X-ray source, such as a synchrotron light source, may produce higher resolution moiré images, due to the size and cost of such higher quality X-ray sources, use of higher quality X-ray sources is impractical for medical purposes. Therefore, deblurring is required to be performed for images generated using an X-ray Talbot Imaging system such as the system 100.

As described above, the X-ray Talbot (XT) interferometer system 100 uses the source grating G0 101 to generate an array of virtual point sources for forming the self-image 120. Projecting each single virtual point source generated at the source grating G0 101 onto the object 102 and onto the phase grating G1 110 produces a sharp Talbot image with good contrast/visibility. However, due to the existence of multiple virtual point sources at the source grating G0 101, distributed on a regular grid, the sum of the sharp Talbot images becomes blurry with less contrast. The blurring can be modelled using a linear convolution between the source point spread function (PSF) (or “source impulse response”) and the object information. The blurring resulting from the multiple virtual point sources at the source grating G0 101 is referred to below as “source blurring”.

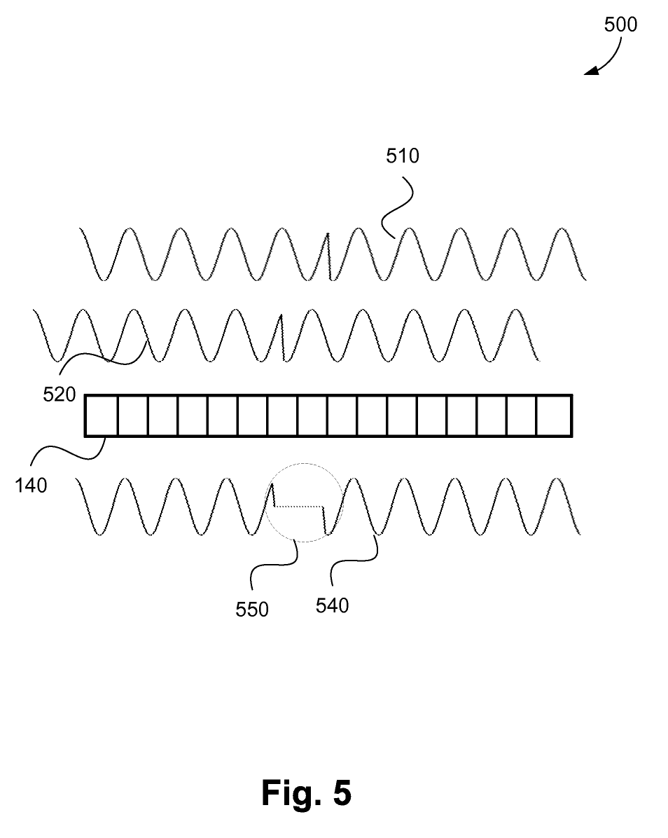

The effect of source blurring on the one-dimensional fringe image projected by the phase grating G1 110 without the object 102 will now be described with reference to FIG. 4. As described above, the pitch p₂ of the absorption grating G2 130 and the pitch p₀ of the source grating G0 101 of the X-ray Talbot (XT) interferometer system 100 of FIG. 1 obey the rule defined by Equation (1). Due to the constraint described in Equation (1), two fringe images 404 and 405 formed by two virtual sources 410 and 420 that are p₀ apart are shifted with respect to each other by the value of the period, p₂, which represents the period of the fringe images 404 and 405. The two fringe images 404 and 405, without the deformation introduced by the object 102, reinforce each other and form a stronger fringe image 406, where the fringe 406 is the fringe image detected by the scintillation detector 140. As each virtual source on the source grating G0 101 is small enough to be considered a point source, each of the two fringe images 404 and 405 has good visibility/contrast. Therefore, the sum of the two fringe images 404 and 405 has good visibility/contrast.

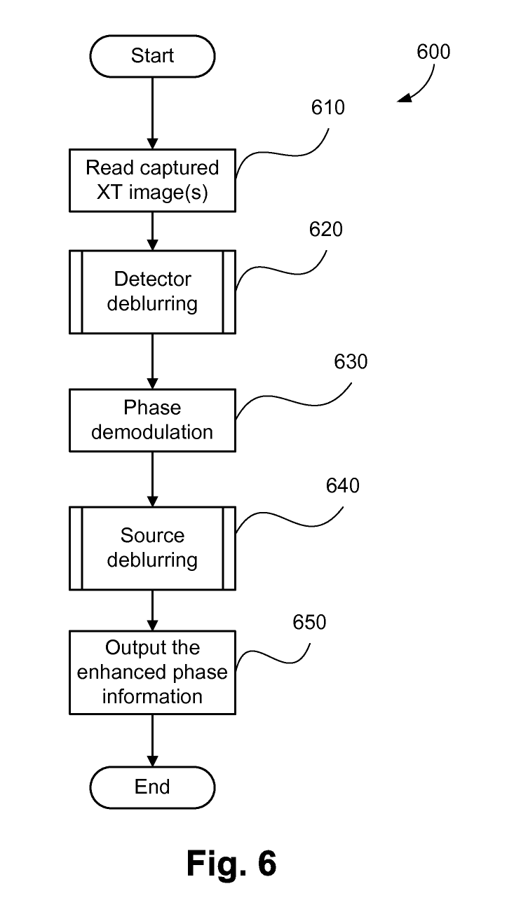

If an object (e.g., object 102) is present in the X-ray Talbot (XT) interferometer system 100, the fringe image projected by each virtual source 410 and 420 will be deformed. Adding several deformed fringe images together introduces blurring. The effect of the source blurring on the one-dimensional fringe image projected by the phase grating G1 110 and an object 102 will be described with reference to FIG. 5. In FIG. 5, a fringe image 510 formed by one virtual source on source grating G0 101 and a fringe image 520 formed by another virtual source which is p₀ away from the first virtual source. When the two fringe images 510 and 520 are projected onto the absorption grating G2 130, the two fringe images 510 and 520 are shifted with respect to each other by the period p₂ which is the fringe period of the projected G1 self-image 120. The shifting of the two fringe images 510 and 520 shown in FIG. 5 is similar to the shifting of the two fringe images 404 and 405 described above with reference to FIG. 4. However, because the two fringe images 510 and 520 are deformed by the object 102, the two fringe images 510 and 520 do not strictly reinforce each other in some positions. Instead, the two fringe images 510 and 520 have very different or even opposite phases at some positions, which results in a signal with very small or even zero amplitude.

The scintillation detector 140 is shown in FIG. 5 and the sum of fringe image 510 and the fringe image 520 is shown as fringe image 540 in FIG. 5. As seen in FIG. 5, the sum of two deformed fringe images 510 and 520 produce a fringe image 540 with less contrast in the area 550 with considerable phase changes.

Since source blurring can be modelled with a linear convolution, a deconvolution method can be applied to remove the blurring caused by finite source size. In the X-ray Talbot (XT) interferometer system 100, blurring also occurs at the scintillation detector 140. As described above, the scintillation detector 140 is an image detector with a scintillator coupled to an electronic light, where the scintillator is used to convert X-ray energy to visible light. The blurring occurs at the scintillation detector 140 both due to a scintillator point spread function (PSF) and the limited resolution of the coupled electronic light sensor. Blurring effects of the scintillator and the electronic light sensor can be modelled with a linear convolution. Further, because the electronic light sensor follows the scintillator immediately in the imaging process, an overall point spread function (PSF) that models the detector blurring can be assumed. The overall blurring coming from the scintillation detector 140 is referred to as the “detector blurring” in this disclosure.

For an imaging system using visible lights, the optical characteristics of the imaging system often play an important role in a deblurring process. Meanwhile, due to the small refractive index of X-rays, manipulation of X-rays is done by reflection, diffraction and interference instead of refraction. Furthermore, in an interferometer such as the X-ray Talbot interferometer system 100, there is very little optical blurring involved. Therefore, optical characteristics are not considered in the arrangements described here. However, when there are significant optical parts in a system using a different light source than X-ray, the optical characteristics of the optical parts need to be considered and dealt with separately.

The scintillation detector 140 is used for capturing a moiré image generated through the image formation process described above including source blurring followed by grating modulation followed by detector blurring. The scintillation detector 140 is adapted to capture the moiré image from the source grating G0 101, the captured moiré image being dependent on the impulse response of the source 104 and characteristics of the detector 140 as described in detail below. To recover phase information of the object 102, the image formation process is reversed. That is, deblurring is applied to the captured moiré image by first performing detector deblurring, using the characteristics of the scintillation detector 140, to attenuate artefacts introduced by the detector 140. Analysis or demodulation, followed by source deblurring, is then performed to enhance contrast in the demodulated image.

Phase demodulation is not considered in detail in this disclosure. A general description of phase demodulation in an X-ray Talbot (XT) interferometer is provided and does not refer to any specific method of phase demodulation. Some relevant details of phase demodulation are presented, when necessary, in order to describe the deblurring process. Methods are described below for demodulating a processed image to determine a demodulated image. The demodulated image is processed using the determined source point spread function (or source impulse response) to enhance contrast in the demodulated image. The demodulated image may be determined using a non-linear demodulation method.

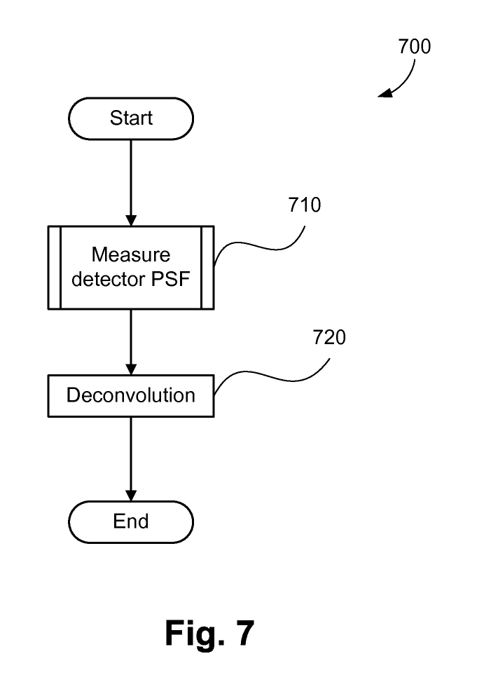

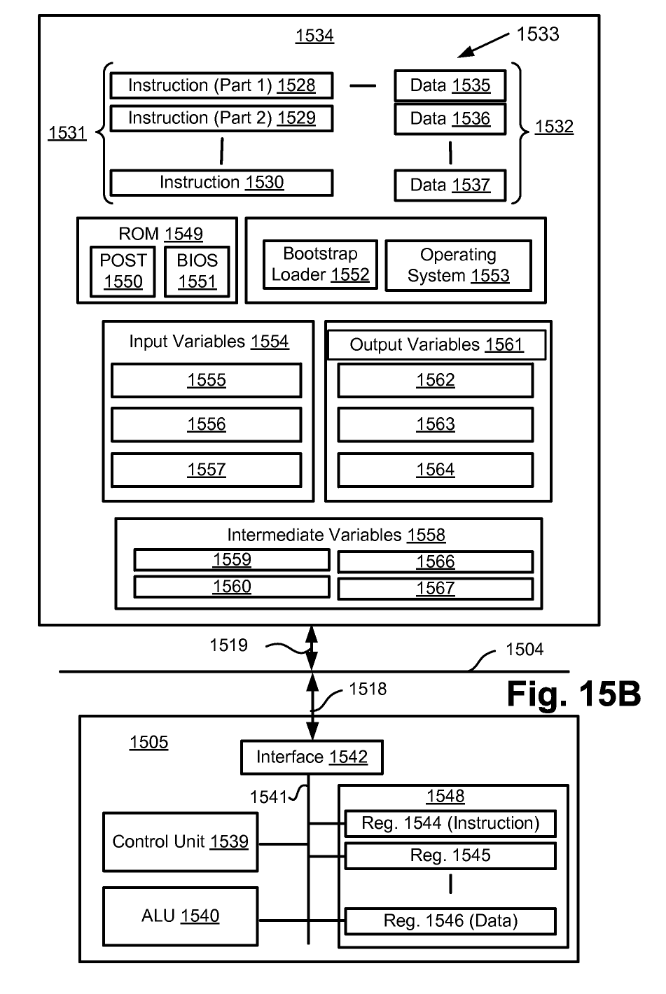

An image processing method 600 will now be described with reference to FIG. 6. The method 600 performs deblurring on processed images. FIGS. 15A and 15B depict a general-purpose computer system 1500, upon which the method 600, and other methods described here can be practiced.

As seen in FIG. 15A, the computer system 1500 includes: a computer module 1501; input devices such as a keyboard 1502, a mouse pointer device 1503, a scanner 1526, a camera 1527, and a microphone 1580; and output devices including a printer 1515, a display device 1514 and loudspeakers 1517. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an number of input/output (I/O) interfaces including: an audio-video interface 1507 that couples to the video display 1514, loudspeakers 1517 and microphone 1580; an I/O interface 1513 that couples to the keyboard 1502, mouse 1503, scanner 1526, camera 1527 and optionally a joystick or other human interface device (not illustrated); and an interface 1508 for the external modem 1516 and printer 1515. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 15A, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 and 1513 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1500.

The components 1505 to 1513 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple Mac™ or a like computer systems.

The method 600, and the other methods described here, may be implemented using the computer system 1500 wherein the processes of FIGS. 6, 7 and 8, to be described, may be implemented as one or more software application programs 1533 executable within the computer system 1500. In particular, the steps of the described methods are effected by instructions 1531 (see FIG. 15B) in the software 1533 that are carried out within the computer system 1500. The software instructions 1531 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for implementing the described methods.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon the display 1514. Through manipulation of typically the keyboard 1502 and the mouse 1503, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1517 and user voice commands input via the microphone 1580.

FIG. 15B is a detailed schematic block diagram of the processor 1505 and a “memory” 1534. The memory 1534 represents a logical aggregation of all the memory modules (including the HDD 1509 and semiconductor memory 1506) that can be accessed by the computer module 1501 in FIG. 15A.

When the computer module 1501 is initially powered up, a power-on self-test (POST) program 1550 executes. The POST program 1550 is typically stored in a ROM 1549 of the semiconductor memory 1506 of FIG. 15A. A hardware device such as the ROM 1549 storing software is sometimes referred to as firmware. The POST program 1550 examines hardware within the computer module 1501 to ensure proper functioning and typically checks the processor 1505, the memory 1534 (1509, 1506), and a basic input-output systems software (BIOS) module 1551, also typically stored in the ROM 1549, for correct operation. Once the POST program 1550 has run successfully, the BIOS 1551 activates the hard disk drive 1510 of FIG. 15A. Activation of the hard disk drive 1510 causes a bootstrap loader program 1552 that is resident on the hard disk drive 1510 to execute via the processor 1505. This loads an operating system 1553 into the RAM memory 1506, upon which the operating system 1553 commences operation. The operating system 1553 is a system level application, executable by the processor 1505, to fulfil various high level functions, including processor management, memory management, device management, storage management, software application interface, and generic user interface.

The operating system 1553 manages the memory 1534 (1509, 1506) to ensure that each process or application running on the computer module 1501 has sufficient memory in which to execute without colliding with memory allocated to another process. Furthermore, the different types of memory available in the system 1500 of FIG. 15A must be used properly so that each process can run effectively. Accordingly, the aggregated memory 1534 is not intended to illustrate how particular segments of memory are allocated (unless otherwise stated), but rather to provide a general view of the memory accessible by the computer system 1500 and how such is used.

As shown in FIG. 15B, the processor 1505 includes a number of functional modules including a control unit 1539, an arithmetic logic unit (ALU) 1540, and a local or internal memory 1548, sometimes called a cache memory. The cache memory 1548 typically include a number of storage registers 1544-1546 in a register section. One or more internal busses 1541 functionally interconnect these functional modules. The processor 1505 typically also has one or more interfaces 1542 for communicating with external devices via the system bus 1504, using a connection 1518. The memory 1534 is coupled to the bus 1504 using a connection 1519.

The application program 1533 includes a sequence of instructions 1531 that may include conditional branch and loop instructions. The program 1533 may also include data 1532 which is used in execution of the program 1533. The instructions 1531 and the data 1532 are stored in memory locations 1528, 1529, 1530 and 1535, 1536, 1537, respectively. Depending upon the relative size of the instructions 1531 and the memory locations 1528-1530, a particular instruction may be stored in a single memory location as depicted by the instruction shown in the memory location 1530. Alternately, an instruction may be segmented into a number of parts each of which is stored in a separate memory location, as depicted by the instruction segments shown in the memory locations 1528 and 1529.

In general, the processor 1505 is given a set of instructions which are executed therein. The processor 1105 waits for a subsequent input, to which the processor 1505 reacts to by executing another set of instructions. Each input may be provided from one or more of a number of sources, including data generated by one or more of the input devices 1502, 1503, data received from an external source across one of the networks 1520, 1502, data retrieved from one of the storage devices 1506, 1509 or data retrieved from a storage medium 1525 inserted into the corresponding reader 1512, all depicted in FIG. 15A. The execution of a set of the instructions may in some cases result in output of data. Execution may also involve storing data or variables to the memory 1534.

The disclosed arrangements use input variables 1554, which are stored in the memory 1534 in corresponding memory locations 1555, 1556, 1557. The disclosed arrangements produce output variables 1561, which are stored in the memory 1534 in corresponding memory locations 1562, 1563, 1564. Intermediate variables 1558 may be stored in memory locations 1559, 1560, 1566 and 1567.

Referring to the processor 1505 of FIG. 15B, the registers 1544, 1545, 1546, the arithmetic logic unit (ALU) 1540, and the control unit 1539 work together to perform sequences of micro-operations needed to perform “fetch, decode, and execute” cycles for every instruction in the instruction set making up the program 1533. Each fetch, decode, and execute cycle comprises:

a fetch operation, which fetches or reads an instruction 1531 from a memory location 1528, 1529, 1530;

a decode operation in which the control unit 1539 determines which instruction has been fetched; and

an execute operation in which the control unit 1539 and/or the ALU 1540 execute the instruction.

Thereafter, a further fetch, decode, and execute cycle for the next instruction may be executed. Similarly, a store cycle may be performed by which the control unit 1539 stores or writes a value to a memory location 1532.

Each step or sub-process in the processes of FIGS. 6, 7 and 8 is associated with one or more segments of the program 1533 and is performed by the register section 1544, 1545, 1547, the ALU 1540, and the control unit 1539 in the processor 1505 working together to perform the fetch, decode, and execute cycles for every instruction in the instruction set for the noted segments of the program 1533.

The described methods may alternatively be implemented in dedicated hardware such as one or more integrated circuits performing the functions or sub functions of the described methods. Such dedicated hardware may include graphic processors, digital signal processors, or one or more microprocessors and associated memories.

The method 600 will be described by way of example with reference to the X-ray Talbot interferometer system 100 shown in FIG. 1 and the object 102. The X-ray Talbot interferometer system 100 is used for capturing X-ray Talbot (XT) images.

The method 600 begins at reading step 610, where X-ray Talbot (XT) images captured by the X-ray Talbot interferometer system 100 are read under execution of the processor 1505. The X-ray Talbot (XT) images may be read from memory 1506, for example, after being captured by the interferometer system 100 and stored in the memory 1506. Depending on the type of phase demodulation method used in the method 600, the number of X-ray Talbot (XT) images read at step 610 can range from one (1) to more than sixteen (16). As described below, the point spread function (PSF) of the source 104 (or source impulse response) and the point spread function (PSF) of the detector 140 (or detector impulse response) of the interferometer system 100 are determined by capturing two or more further images of the X-ray energy generated by the source 104. As also described, in one of the captured further images, the point spread function (PSF) of the source 104 may be dominating over the point spread function (PSF) of the detector 140. In another one of the captured further images the point spread function (PSF) of the detector 140 is dominating over the point spread function (PSF) of the source 104.

If a windowed Fourier transform (WFT) method is used for demodulation in the method 600, only a single captured image is required to be read at step 610. However, an extra reference image may be captured for calibration purposes.

If a phase stepping method is used for demodulation in the method 600 and the gratings 101, 110 and 120 are one-dimensional gratings, then at least three captured images are read at step 610. If a phase stepping method is used for demodulation in the method 600 and the gratings 101, 110 and 120 are two-dimensional gratings, then at least five (5) images are captured and read at step 610. In one arrangement, sixteen (16) or even twenty-seven (27) images are captured and read at step 610 for oversampling.

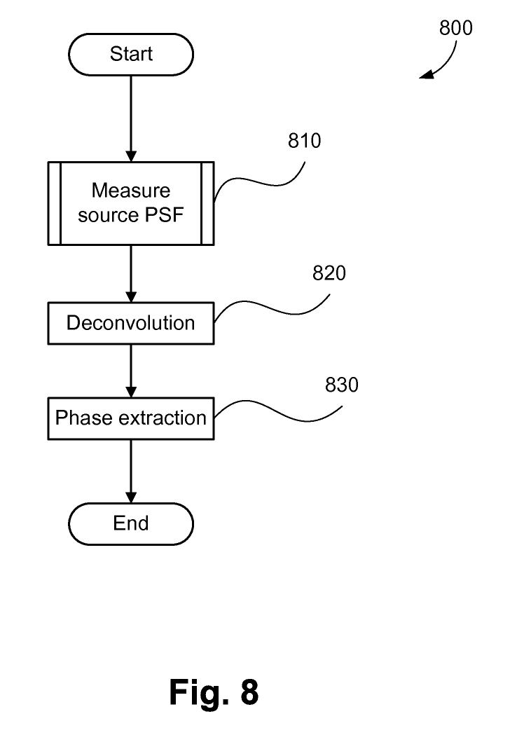

After the X-ray Talbot (XT) images are read in at step 610, the method 600 continues at a detector deblurring step 620, where a detector deblurring method 700 (see FIG. 7) is applied directly to the captured X-ray Talbot (XT) images to produce one or more deblurred images (or “deblurred moiré images”). As will be described in detail below with reference to FIG. 7, the detector deblurring method 700 is configured for processing one or more of the captured X-ray Talbot (XT) images using a determined detector point spread function (or detector impulse response) to attenuate artefacts introduced to the captured X-ray Talbot (XT) images by the detector 140.

Then at demodulating step 630, phase demodulation is applied to the deblurred images processed at step 620, under execution of the processor 1505, to recover phase information associated with the object 102. Object phase information reveals important shape and density information about the object 102. As will be described in detail below, the phase demodulation executed at step 630 produces at least one demodulated image. Artefacts introduced by the source 104 are present in the demodulated image.

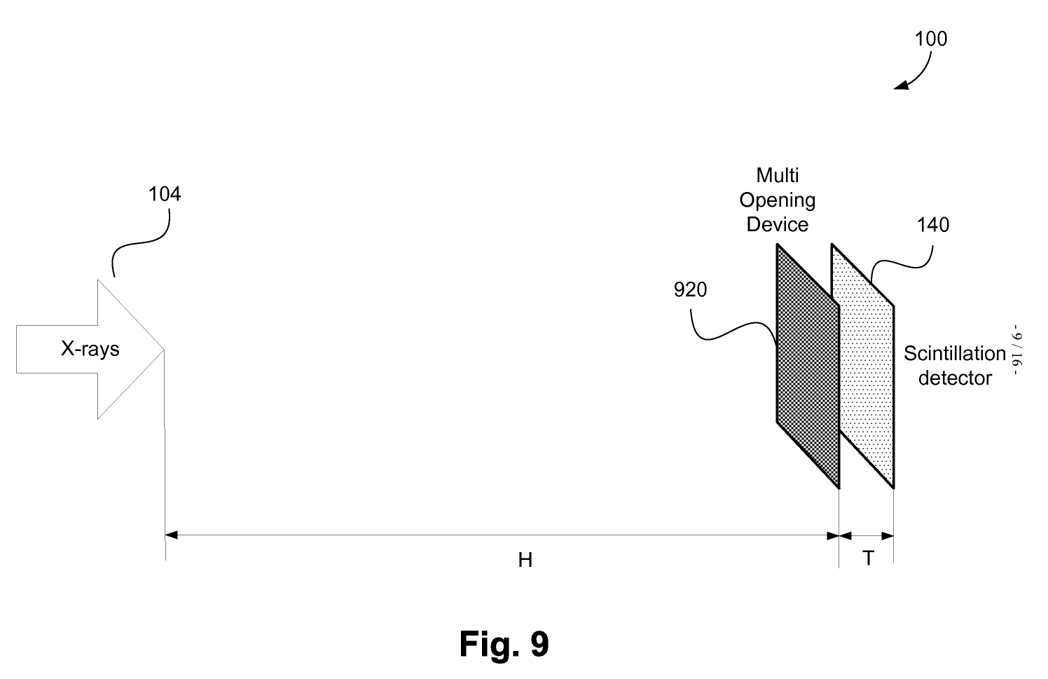

The method 600 then proceeds to source deblurring step 640, where the recovered phase information of the object 102 is then passed to a source deblurring method 800 (see FIG. 8). The method 800 is used for processing the demodulated image using a determined source impulse response to substantially reduce artefacts in the demodulated image introduced by the X-ray source 104. The method 800 determines object phase information and recovers the deblurred X-ray Talbot (XT) image determined in accordance with the method 700. A source deblurring method 800, as executed at step 640, will be described in detail below with reference to FIG. 8.

The method 600 then concludes at an outputting step 650, where the phase information for the object 102 is output to the display 1514. The object 102 is displayed with enhanced resolution. Alternatively, further analysis may be performed on the object phase information at step 650.

The detector deblurring step 620, the demodulating step 630 and the source deblurring step 640 of the method 600 are ordered as shown in FIG. 6, as the phase demodulation executed at demodulating step 630 often involves non-linearity. The detector blurring and the source blurring are processed in the order corresponding to the order of image formation described above.

In steps 620 and 640, detector deblurring and source deblurring are applied to the X-ray Talbot (XT) images (i.e., as read at step 610) before and after the phase demodulation performed at step 630. Since detector deblurring is applied to the captured fringe image and source deblurring is applied to demodulated images, deblurring methods used in steps 620 and 640 are different and the point spread functions (PSF) assumed are different.

The detector deblurring method 700, as executed at step 620, will now be described with reference to FIG. 7. The method 700 is implemented as one or more software code modules of the software application program 1533 resident in the hard disk drive 1510 and being controlled in their execution by the processor 1505. In the method 700, deblurring is applied to the captured X-ray Talbot (XT) images.

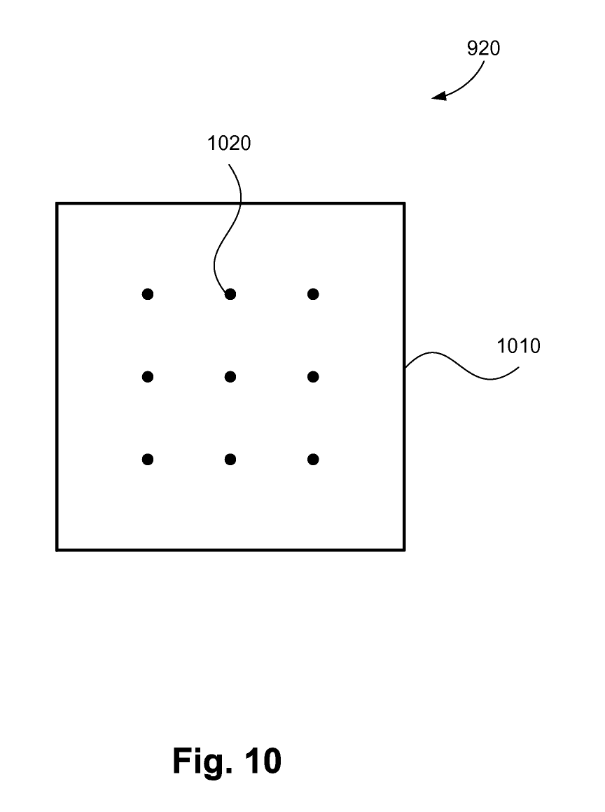

The method 700 begins at measuring step 710, where the point spread function (PSF) due to the scintillator and the image sensor resolution is measured under execution of the processor 1505. The point spread function measured at step 710 is the impulse response of the detector of the interferometer system 100. The measurement of the detector point spread function (PSF) as executed at step 710, will be described with reference to FIG. 9.

In one arrangement, the point spread function (PSF) of the detector 140 (or detector impulse response) may be predetermined and stored, for example, in the memory 1506. In such an arrangement, the processor 1505 may be configured for receiving the point spread function (PSF) of the detector 140 (or detector impulse response) of the interferometer system 100 from the memory 1506 at step 710.

In another arrangement, the point spread function (PSF) of the detector 140 (or detector impulse response) may be determined in advance, at manufacturing stage, and stored on a remote server 1590 connected to the network 1520. In such an arrangement, the processor 1505 may be configured for receiving the point spread function (PSF) of the detector 140 (or detector impulse response) of the interferometer system 100 from the server 1590, via the network 1590, at step 710.

Then at deconvolution step 720, an image restoration method is applied to the captured X-ray Talbot (XT) images to remove the impact of the detector point spread function (PSF) in the X-ray Talbot (XT) images. As described above, the X-ray Talbot (XT) images may be read from memory 1506, for example.

The measurement of the detector point spread function (PSF) as executed at step 710, will be described with reference to FIG. 9. FIG. 9 shows the X-ray Talbot interferometer system 100 of FIG. 1 except that only the X-ray source 104 and the scintillation detector 140 are used to measure the detector point spread function (PSF) (or detector impulse response). As seen in FIG. 9, a multi-opening device 920 is positioned between the X-ray source 104 and the scintillation detector 140 towards the scintillation detector 140. The detector point spread function (or detector impulse response) may be determined by capturing an image produced by X-rays of the source 104 passing through the device 920. In other words, the image of the detector point spread function (or detector impulse response) is produced by the electromagnetic waves (or “energy waves”) from the source 104 passing through the multi-opening device 920 being positioned towards the scintillation detector 140. By positioning the multi-opening device 920 towards the scintillation detector 140, the detector point spread function (or detector impulse response) in the captured image is dominating over (i.e., larger than) the source point spread function (or source impulse response) in the captured image. Therefore, for the purposes of the present disclosure, the source point spread function (or source impulse response) in the captured image can be ignored. The source grating G0 101, the phase grating G1 110 and the absorption grating G2 130 are not included.

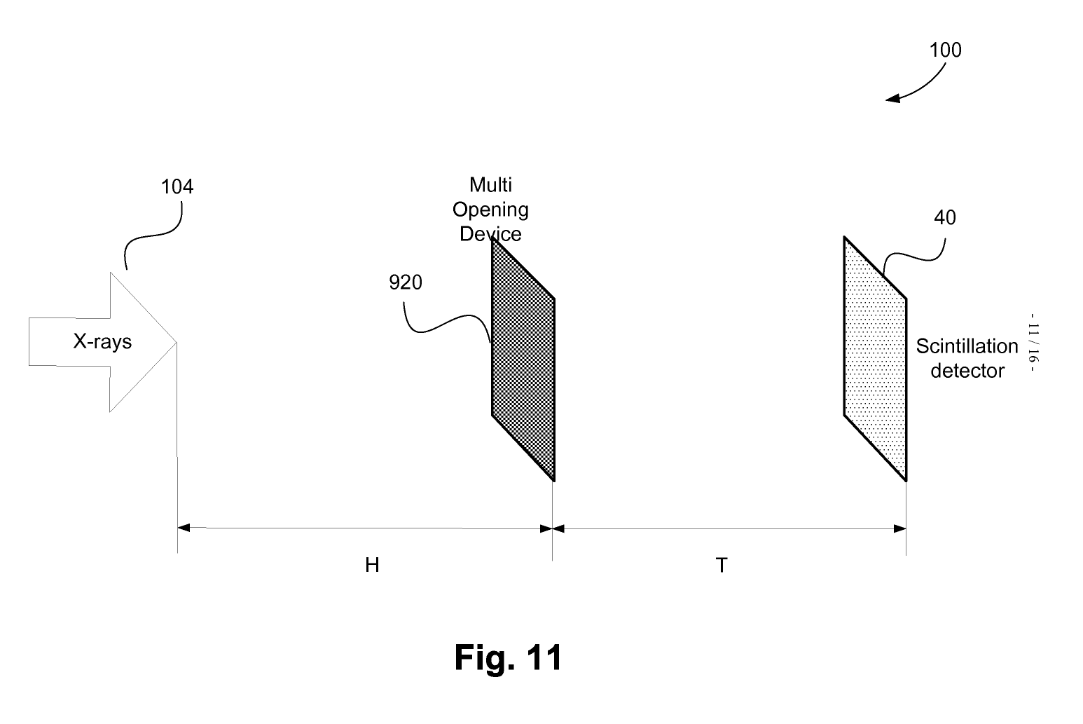

The multi-opening device 920 is shown in more detail in FIG. 10. Similar to the gratings 101, 110 and 130, the multi-opening device 920 is an aperture device in the form of a thin plate 1010 which in use is positioned substantially parallel to the surface of the scintillation detector 140. The thin plate 1010 may be made of gold so that the plate 1010 can effectively absorb X-ray energy. In the centre of the thin plate 1010, there are a plurality of small (e.g., 20 microns wide) openings (e.g., 1020) that let at least a portion of X-ray energy pass through the plate 1010. The openings (e.g., 1020) may be in the form of a pinhole where the shape of the openings (e.g., 1020) is substantially circular so that the multi-opening device 920 is in the form of a pinhole device. The device 920 is positioned adjacent to the detector 140 as seen in FIG. 9. The openings (e.g., 1020) may be of any suitable shape as the shape of the openings of the device 920 does not affect the detector point spread function (PSF) measurement since each opening is considered a point source. However, as described above, each of the openings is small (e.g., 20 microns wide).

Referring back to FIG. 9, when the multi-opening device 920 is placed immediately adjacent to the scintillation detector 140, the X-ray projected onto the detector 140 through the openings (e.g., 1020) is considered a point source. Therefore, the image of the point source captured on the scintillation detector 140 is an accurate measurement of the point spread function of the detector 140. In order for the projected X-ray to be considered a point source, the multi-opening device 920 needs to be sufficiently close to the scintillation detector 140 and sufficiently far away from the X-ray source 104.

For example, in one arrangement, the distance, H, between the multi-opening device 920 and the X-ray source 104 is one-hundred and ninety six (196) cm. In such an arrangement, the distance, T, between the multi-opening device 920 and the scintillation detector 140 is four (4) cm. The distance, T, between the multi-opening device 920 and the scintillation detector 140 is sufficiently small compared to the distance, H, between the X-ray source 104 and the multi-opening device 920. Due to the assumption that the X-ray light passing through an opening is a point source, the point spread function (PSF) captured using the configuration of the interferometer system 100 in FIG. 9 is considered, as the pure detector point spread function (PSF). The point spread function (PSF) measured using the configuration of FIG. 9 does not include any significant effect (e.g., artefacts) from the X-ray source 104.

The multi-opening device 920 may be in the form of any device that generates a point source. For example, multi-opening device 920 can be a thin plate with just one small opening in the middle. Having more than one opening on the multi-opening device 920, however, provides more information on the characteristics of the detector blurring. When the multiple openings are distributed across the thin plate, local characteristics of the detector blurring may be collected. Multiple openings distributed across the thin plate are useful considering that the detector blurring is not necessarily uniform.

Once the detector point spread function (PSF) is measured, a deconvolution method may be applied to the captured X-ray images to remove the impact of the detector blurring in step 720. Any linear or non-linear deconvolution method may be applied to the captured X-ray images. For example, in one arrangement, the Richardson-Lucy deconvolution method is used to fit the dominant Poisson noise in low-brilliance X-ray imaging.

Methods using other expectation maximization style deconvolution may also be applied to the captured X-ray images. In another arrangement, a simple Wiener filter is used, where the power spectrum ratio between the noise and an underlying signal is estimated using a reference capture such as an X-ray Talbot (XT) image without the object 102.

When there is more than one captured X-ray image, different deconvolution methods can be applied to different ones of the X-ray images or the same method can be used for all of the captured X-ray images.

In one arrangement, a shift-invariant blurring process is assumed to cause the detector blurring. In such an arrangement, a fast Fourier transform (FFT) based deblurring method can be used for better speed performance. Where a fast Fourier transform (FFT) based deblurring method is used, although there are nine (9) openings (or pinholes) on the multi-opening device 1010 shown FIG. 10, which gives nine (9) light spots on the captured detector point spread function (PSF) image, only one light spot is used as the detector point spread function (PSF). In one arrangement, the average value of the nine (9) light spots is used as the overall detector point spread function (PSF), which has the advantage of cancelling out noise and other irregularities.

As described above, at step 630, a phase demodulation process is applied to the deblurred image(s) (or “deblurred moiré image(s)”) to recover the object phase information. Any phase demodulation method may be applied to the deblurred moiré images at step 630. For example, a windowed Fourier transform (WFT) method or phase stepping method may be applied to the deblurred images at step 630. However, for ease of explanation, step 630 will be described below where the object phase information is demodulated using a phase stepping method.

Depending on the mathematical model assumed for the modulation process of the interferometer system 100, the format of the demodulation results will be different. However, the demodulation results represent the X-ray phase change caused by the object 102 no matter which mathematical model is used.

In one arrangement, the gratings 101, 110 and 130 of the X-ray Talbot (XT) interferometer system 100 are two-dimensional gratings, and the phase demodulation step 630 generates three images: an absorption image A, an x modulation image Mₓ and a y modulation image M_{y}. The absorption image A reflects the amount of X-ray energy that tissue absorbs, similar to conventional X-ray images. The x and y modulation image are two-dimensional with complex values. The x modulation image Mₓ may be determined in accordance with Equation (4), as follows:

Mₓ(r)=Bₓ(r)e^{iφx(r)},M_{y}(r)=B_{y}(r)e^{iφy(r)}, (4)

where r=(x, y) represents the position in a captured X-ray Talbot (XT) image, Bₓ(r) and B_{y}(r) are the x and y modulation strength, respectively. In Equation (4), object phase information φₓ(r) and φ_{y}(r) reveals important shape and density information of the object, giving critical information for medical diagnosis when applied to soft tissues.

Any suitable phase demodulation method that produces a phase image associated with a modulation strength image, may be executed at step 630.

The source deblurring method executed at step 640 depends on the configuration of the X-ray Talbot interferometer system 100 as the source deblurring method influences the impact of source blurring on an X-ray Talbot (XT) image. Blurring happens at completely different stages to different degrees for different configurations of the X-ray Talbot interferometer system 100.

For example, in the X-ray Talbot (XT) interferometer system 100, when the phase grating G1 110 is close to the X-ray source 104 and far away from the absorption grating G2 130 and the scintillation detector 140, the period of the self-image 120 is large. As described above, the grating G2 130 and the scintillation detector 140 are considered to be at the same location. The magnification of the object information, as determined in accordance with Equation (2), is also large as the distance d between the phase grating G1 110 and the absorption grating G2 130 is comparable to or even larger than the distance L between the source grating G0 101 and the phase grating G1 110. In one arrangement, the magnification factor of greater than 1.5 is used for the X-ray Talbot (XT) interferometer system 100, so that the distance d between the phase grating G1 110 and the absorption grating G2 130 is greater than L/2.

One advantage of using a large magnification factor is that a better angular sensitivity is achieved so that a smallest refraction angle is detectable by the X-ray Talbot (XT) interferometer system 100. A higher angular sensitivity results in a better resolution in the X-ray Talbot (XT) images captured as at step 610. Angular sensitivity may be determined based on the ratio r between the distance d and the pitch p₁ 304 of the grating G1 110, divided by the magnification of the setup. Moving the phase grating G1 110 further away from the absorption grating G2 130 increases the angular sensitivity of the X-ray Talbot (XT) interferometer system 100 up to a certain point.

If a large magnification factor is used the source blurring has a much larger effect on a captured X-ray Talbot image due to the relationship defined in Equation (2).

The X-ray Talbot (XT) interferometer system 100 may also be configured for smaller magnification, where the grating G1 110 is close to the grating G2 130, so as to enable the scintillation detector 140 to be physically smaller. If the X-ray Talbot (XT) interferometer system 100 is configured for large magnification, the source point spread function (PSF) needs to be measured accurately due to the strong impact of source blurring on a captured X-ray Talbot image.

The source deblurring method 800, as executed at step 640, will now be described in detail below with reference to FIG. 8. The method 800 determines object phase information which may be stored in the memory 1506 by the processor 1505. The method 800 is implemented as one or more software code modules of the software application program 1533 resident in the hard disk drive 1510 and being controlled in their execution by the processor 1505.

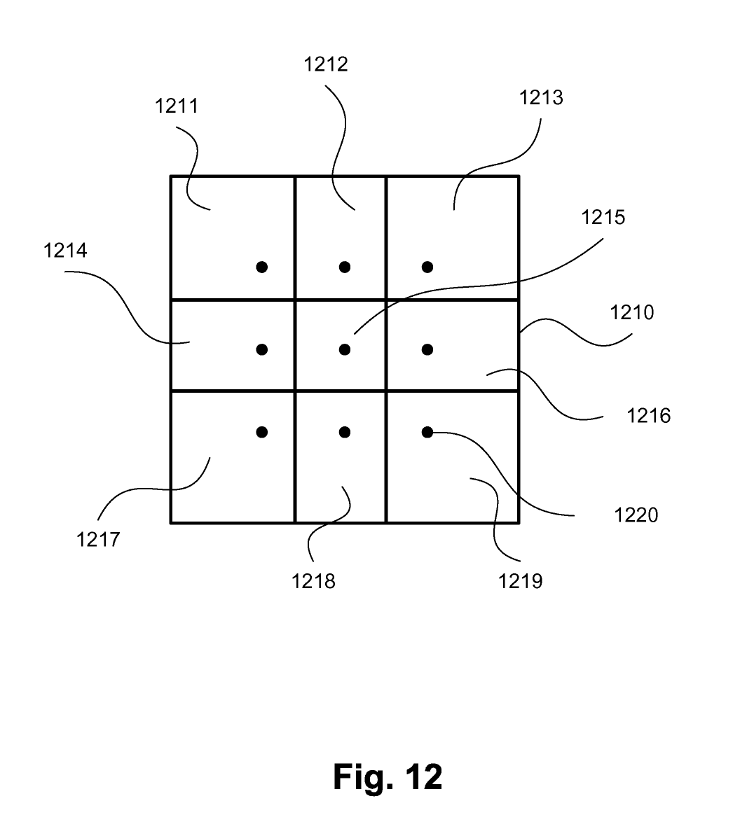

The method 800 begins at measuring step 810, where the source point spread function (PSF) is measured under execution of the processor 1505. The source point spread function (PSF) is the impulse response of the source 104 of the interferometer system 100. The measurement of the source point spread function at step 810 will be described in detail below with reference to FIG. 11.

In one arrangement, the point spread function (PSF) of the source 104 (or source impulse response) may be predetermined for a particular configuration of the XT system 100 and be stored, for example, in the memory 1506. In such an arrangement, the processor 1505 may be configured for receiving the point spread function (PSF) of the source 104 (or source impulse response) of the interferometer system 100 from the memory 1506 at step 810.

In another arrangement, the point spread function (PSF) of the source 104 (or source impulse response) may be determined on a remote server 1590 connected to the network 1520 for several configurations of the interferometer system 100. In such an arrangement, the processor 1505 may be configured for receiving the point spread function (PSF) of the source 104 (or source impulse response) corresponding to a particular configuration of the interferometer system 100 from the server 1590, via the network 1590, at step 810. For the purpose of the present disclosure, a configuration of the interferometer system 100 refers to an arrangement of the source grating G0 101, the phase grating G1 110, the absorption grating G2 130, and the scintillation detector 140 relative to each other.

As will be described below, the point spread function (PSF) of the source 104 (or source impulse response) is determined independently of the point spread function (PSF) of the detector 140 (or detector impulse response).

Then at deconvolution step 820, a deconvolution method is executed to recover the deblurred X-ray Talbot (XT) image which was determined in accordance with the method 700. The deconvolution method is applied to the output of the phase demodulation step 630. The deconvolution method executed at step 820 will be described in more detail below.

The method 800 concludes at extraction step 830, where the object phase information is extracted from the deblurred X-ray Talbot (XT) image recovered at step 820. The extraction of the object phase information at step 830 will be described in more detail below.

The measurement of the source point spread function at step 810 will now be described in more detail with reference to FIG. 11. FIG. 11 shows the X-ray Talbot interferometer system 100 of FIG. 1 except that only the X-ray source 101 and the scintillation detector 140 are used to measure the source point spread function (PSF). Similar to FIG. 9, where the point spread function (PSF) of the scintillation detector 140 is measured, the X-ray Talbot interferometer system 100 may be configured as seen in FIG. 11 to use the multi-opening device 920 to measure the source point spread function (PSF) of the source 104. In the configuration of FIG. 11, instead of placing the multi-opening device 920 very close to the scintillation detector 140, the multi-opening device 920 is placed closer to the X-ray source 101. The source point spread function (or source impulse response) may be determined by positioning the multi-opening device 920 at a position between the phase grating G1 110 and the source 104 and moving the device 920 towards the source 104.

In order to reproduce the effect of the X-ray source 101 on the image quality, the multi-opening device 920 is placed at the same location as the phase grating G1 110 is placed in FIG. 1. The source point spread function (or source impulse response) may be determined by positioning the multi-opening device 920 at the position of the phase grating G1 110. Once the position of the multi-opening device 920 is determined, an image of the source point spread function (or source impulse response) of the X-ray source 104 (or “energy source”) of the system 100 is captured by the scintillation detector 140 of the interferometer system 100. The captured image is produced by the electromagnetic waves (or “energy waves”) from the X-ray source 104 passing through the multi-opening device 920 being positioned towards the X-ray source 104, according to the configuration of FIG. 11.

In one arrangement, the distance, H, between the multi-opening device 920 and the X-ray source 104 is one hundred and twenty (120) cm while the distance, T, between the multi-opening device 920 and the scintillation detector 140 is eighty (80) cm. For an arrangement where H=120 cm and T=80 cm, the magnification is (120+80)/120=1.67. Because of the large magnification, a captured source point spread function (PSF) image, which consists of nine (9) light spots representing the projection of the X-ray source through nine (9) openings, reflects the X-ray source characteristics only. By positioning the multi-opening device 920 towards the X-ray source 104, the source point spread function (or source impulse response) in the captured source point spread function (PSF) image is dominating (i.e., larger than) over the detector point spread function (or detector impulse response) in the capture image. The impact from the detector point spread function (PSF) in the captured source point spread function (PSF) image, is considered to be negligible.

When measuring the detector point spread function (PSF), the point spread function (PSF) values measured through the nine (9) holes in the multi-opening device 920 are averaged together to create an overall detector point spread function (PSF). The source point spread function (PSF) may be measured in a similar manner if a shift-invariant blurring is assumed in both detector blurring and source blurring.

However, there is a difference between the measurement of the detector point spread function (PSF) and the source point spread function (PSF). The shape and the brightness of the X-ray source in most X-ray Talbot systems vary depending on operating conditions such as tube voltage. Deterioration of the X-ray source over time may also affect the shape and the brightness. Such deterioration of the X-ray source means that the source point spread function (PSF) measurement is carried out more frequently (e.g., periodically) than the detector point spread function (PSF). The point spread function (PSF) of the X-ray energy source 104 of the interferometer system 100 may be determined periodically. The detector point spread function (PSF) measurement of step 710 can be optional for most image capture processes.

In addition, the multi-opening device 920 plays a different role in the detector PSF measurement than in the source point spread function (PSF) measurement. When measuring the detector point spread function (PSF), the multi-opening device 920 with small pin-holes limits the size of the light spot. The multi-opening device 920 thus produces a group of point sources close to the scintillation detector 140 so that the light spot captured on the scintillation detector 140 is the detector response to a point source. In source point spread function (PSF) measurement, the small point source is produced by the multi-opening device 920 at phase grating G1 110 location according to one arrangement in order to simulate (or model) the effect of each opening of the phase grating G1 110. Therefore, the captured image at the detector 140 is dominated by the blurring effect of the X-ray source on any object placed close to the phase grating G1 110. In some arrangements, the device 920 can be made in a form of an aperture device. In other arrangements, the device 920 comprises only a single opening.

Once the point spread function (PSF) of the detector 140 is measured, the characteristics of the interferometer system 100 will not change for the life of the scintillation detector 140. The source point spread function (PSF), on the other hand, needs to be monitored regularly to minimize the mismatch between the point spread function (PSF) used in deconvolution and actual blurring point spread function (PSF). For example, the source point spread function (PSF) can be measured every time a group of captured X-ray Talbot (XT) images are analysed, or the source point spread function (PSF) can be measured at a regular time (i.e., periodically) such as every week or every day. Whenever a new X-ray source 101 is installed, the source point spread function (PSF) needs to be re-measured due to the great variety of shape and brightness of X-ray sources.

As described above, at step 820, a deconvolution method is applied to the output of the phase demodulation step 630. As described above, in one arrangement, the phase demodulation step 630 generates three images: the absorption image A, the x modulation image Mₓ and the y modulation image M_{y}, as described in Equation (4). Any suitable linear or non-linear deconvolution method can be applied to the demodulation output at step 820. For example, in one arrangement, the Richardson-Lucy deconvolution method is applied to the demodulation output at step 820 to fit the dominant Poisson noise in low-brilliance X-ray imaging. Any other suitable deconvolution method using other expectation maximization style deconvolution can also be applied at step 820 to the output of the phase demodulation. In another arrangement, a Wiener filter is used at step 820, where the power spectrum ratio between the noise and the underlying signal is estimated using a reference capture in the form of an XT image without the object 102.

The deconvolution method is applied to the three images including the absorption image A, the x modulation image Mₓ and the y modulation image M_{y}, independently, at step 820. The same deconvolution method may be applied to each of the three images (i.e., the absorption image A, the x modulation image Mₓ and the y modulation image M_{y}).

Since the x modulation image Mₓ and the y modulation image M_{y} have complex pixel values, the same deconvolution method may be applied separately to the real and imaginary parts of the modulation images. The results of applying the deconvolution method to the real and imaginary parts of the modulation images are then combined together to form a deblurred x modulation image and a deblurred y modulation image, both having complex values. The process of determining a deblurred x modulation image and a deblurred y modulation image can be described using Equations (5), (6). (7) and (8), below:

Mₓ(r)=Bₓ(r)e^{iφx(r)}=Mₓᵣ(r)+iMₓᵢ(r), (5)

M_{y}(r)=B_{y}(r)e^{iφy(r)}=M_{yr}(r)iM_{yi}(r), (6)

\tilde{M}ₓ(r)=D[Mₓᵣ(r)]+iD[Mₓᵢ(r)]=\tilde{B}ₓ(r)e^{i\tilde{φ}x(r)}, (7)

\tilde{M}_{y}(r)=D[M_{yr}(r)]+iD[M_{yi}(r)]=\tilde{B}_{y}(r)e^{i\tilde{φ}y(r)}, (8)

In Equation (5), Mₓᵣ, represents the real part of the x modulation image Mₓ and Mₓᵢ is the imaginary part of the x modulation image Mₓ. Similarly, in Equation (6), M_{yr}, represents the real part of the y modulation image M_{y} and M_{yi} is the imaginary part of the y modulation image M_{y}.

In Equations (7) and (8), the operator D represents a deconvolution operation. The deconvolution operator can be a linear or non-linear deconvolution operation. Equations (7) and (8) show that the deblurred real part D[Mₓᵣ(r)] (D[M_{yr}(r)]) and the deblurred imaginary part D[Mₓᵣ(r)] (D[M_{yi}(r)]) are combined together to form a new complex image \tilde{M}ₓ (\tilde{M}_{y}).

Refer back to FIG. 8, at extraction step 830, the object phase information \tilde{φ}ₓ(r) and \tilde{φ}_{y} (r) as defined in Equations (7) and (8) is extracted from the deblurred images. The object phase information \tilde{φ}ₓ(r) and \tilde{φ}_{y}(r) may be stored in the memory 1506 and/or the hard disk drive 1510. Further analysis or visualization can be applied to the object phase information \tilde{φ}ₓ (r) and \tilde{φ}_{y}(r) for diagnosis purpose if the object 102, for example, provides clinical information. Where the object 102 provides information such as an internal structure of a new material, the raw x and y phase information \tilde{φ}ₓ(r) and \tilde{φ}_{y}(r) can be used.

For the interferometer system 100 described above with reference to FIG. 1, the phase grating G1 110 is located close to the source grating G0 101, so that the magnification of the interferometer system 100 is large (e.g., larger than 1.5). As described above, when the multi-opening device 920 shown in FIG. 11 is placed at the same position as grating G1 110, the source point spread function (PSF) measured reflects the correct size of the X-ray size, and therefore is used directly for source deblurring. Because of the large magnification of such an X-ray Talbot interferometer system, the measured source point spread function (PSF) image is dominated by the X-ray source 101 with very limited impact from the detector 140. In an X-ray Talbot interferometer (XT) system with large magnification, measuring the source point spread function (PSF) by placing the multi-opening device 920 at the location of the grating G1 110 produces an accurate source point spread function (PSF) at the right size with very little interference from the detector 140.

Often, an X-ray Talbot (XT) interferometer system has a much smaller magnification because the phase grating G1 110 is placed closer to the phase grating G2 130. The phase grating G1 110 is typically placed closer to the phase grating G2 130 to avoid small field of view (FOV) due to limited sensor size or to minimize the impact of source blurring. In an X-ray Talbot (XT) interferometer system where the phase grating G1 110 is placed closer to the phase grating G2 130, measuring source point spread function (PSF) by placing the multi-opening device 920 at the position of the grating G1 110 results in a point spread function (PSF) image with mixed source and detector blurring information.

In order to keep the source and detector blurring well separated, in one arrangement, the source point spread function (PSF) is measured by placing the multi-opening device 920 close to the source 101, similar to the configuration of the interferometer in FIG. 11. In such an arrangement, the distance H between the source and the multi-opening device 920 is approximately twice as large as the distance T between the multi-opening device 920 and the scintillation detector 140. The magnification M is approximately one point five (1.5). By placing the multi-opening device 920 closer to the source 101, the impact of detector blurring is minimized.

In an arrangement where the multi-opening device 920 is positioned close to the source 101 the mismatch between the location of the multi-opening device 920 and the location of the grating G1 means that the measured source point spread function (PSF) is a magnified version of the real source point spread function (PSF). Therefore, downsampling is executed in an arrangement where the multi-opening device 920 is positioned close to the source 101 to correct the size of the point spread function (PSF) so that the point spread function (PSF) appears to be measured with a multi-opening device at the location of the grating (G1) 110. Any suitable downsampling method may be executed in an arrangement where the multi-opening device 920 is positioned close to the source 101 described above as long as the downsampling method does not significantly change the profile of the source point spread function (PSF).

Once the source point spread function (PSF) is measured and size-corrected, the same process including detector deblurring, phase demodulation and source deblurring described in FIG. 6 is applied to recover the object phase information.

In one arrangement, a deconvolution method is applied to the detector deblurring process and source deblurring process to reflect the shift-variant property of the X-ray Talbot (XT) interferometer system 100. The multi-opening device 920 used for point spread function (PSF) measurement projects more than one light spot onto the detector 140, each representing the point spread function (PSF) at a particular location of the captured image. As described above, the average point spread function (PSF) of the spots may be used as the detector or source point spread function (PSF). In one arrangement, a deconvolution method is applied to each of the light spots and to corresponding pixels from the deconvolution input.

The multi-opening device 920 in FIG. 10 comprises nine (9) holes so as to project nine (9) light spots on a measured point spread function (PSF) image. Each of the nine (9) light spots can be used to model the blurring at a corresponding neighbourhood in a captured X-ray Talbot image. The matrix that models the detector or source blurring has an irregular structure, instead of being block Toeplitz. Solving such an irregular structure can be expensive as a Fourier domain method cannot be used directly. However, a shift-variant deconvolution method may be applied to address the problem of X-ray Talbot image deconvolution. In one arrangement, the X-ray Talbot image is divided into several non-overlapping regions and each region is assumed to be blurred by a local shift-invariant blurring kernel. Deconvolution results of the non-overlapping regions are ‘sewn’ together to form a deconvolved image, which is referred to as a ‘piece-wise constant’ method.

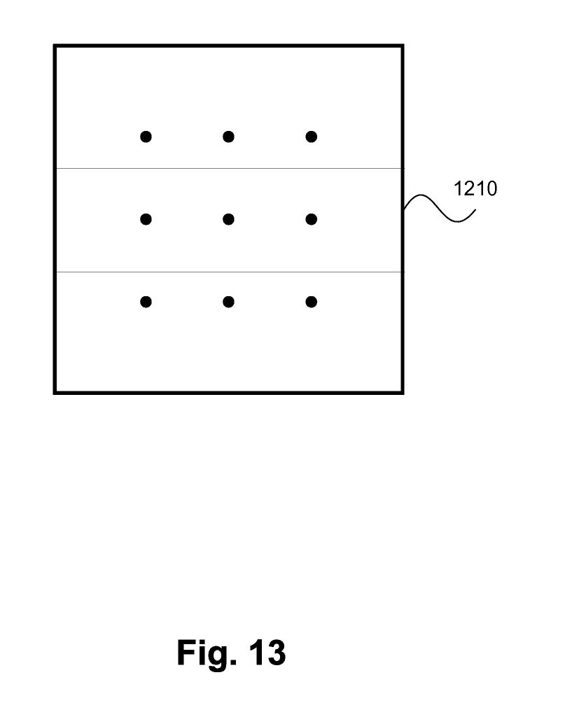

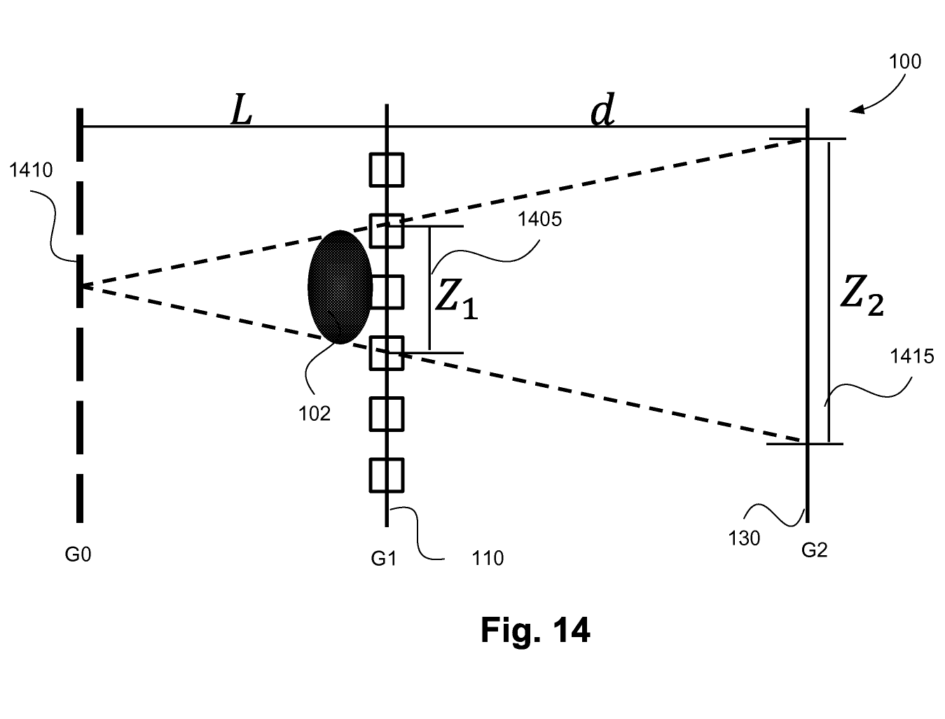

For a multi-opening device, such as the device 1010 shown in FIG. 10, where nine (9) local point spread functions are measured, the image to be deblurred can be divided into nine (9) non-overlapping regions. Each of the nine (9) local point spread functions represents a shift-invariant blurring kernel in a corresponding image region. For example, FIG. 12 shows a captured point spread function (PSF) image 1210 with nine (9) light spots (e.g., 1220). As seen in FIG. 12, each of the regions 1211, 1212, 1213, 1214, 1215, 1216, 1217, 1218 and 1219 represent the local neighbourhood of a corresponding light spot/point spread function (PSF). Many region division patterns other than the division pattern shown in FIG. 12 may be used. For example, if the main variation of blurring is along the y direction, the captured point spread function (PSF) image 1210 can be divided into three regions 1301, 1302 and 1303 as shown in FIG. 13. The average value of the three light spots in each region can be used as a local shift-invariant blurring kernel.

The deconvolution method described above with reference to FIG. 9 may lead to results with border artefacts at the borders of the nine (9) regions. In another arrangement, referred to as a ‘piece-wise linear’ method, linear interpolation may be used to model the blurring at each pixel of the captured point spread function (PSF) image 1210. The deblurring result for a single one of the pixels is calculated using a weighted sum of the deblurring results of several point spread functions that are in the neighbourhood of the particular single pixel.

A main advantage of the above ‘piece-wise constant’ and ‘piece-wise linear’ method is that for each point spread function (PSF), direct fast fourier transform (FFT)-based method can be used, which results in fast computation. The shift-variant deblurring methods can be used in both detector and X-ray source deblurring processes.

In another arrangement, source point spread function (PSF) and detector point spread function (PSF) may be predetermined so that there is no need to measure the point spread function (PSF). The source point spread function (PSF) and detector point spread function (PSF) may be provided by a manufacturer of the X-ray Talbot (XT) interferometer system 100. Alternatively, the source point spread function (PSF) and detector point spread function (PSF) may be described in a document provided with the X-ray Talbot (XT) interferometer system 100. The source point spread function (PSF) and detector point spread function (PSF) provided and applied directly in the detector deblurring, demodulation and source deblurring process described above.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. An image processing method comprising:
receiving an impulse response of a source of an interferometer system;
receiving an impulse response of a detector of the interferometer system, the source impulse response being determined independently of the detector impulse response;
capturing an image of an object generated by a grating of the interferometer system, the image being captured by the detector of the interferometer system;
processing the captured image using the determined detector impulse response to attenuate artefacts introduced by the detector;
demodulating the processed image to produce a demodulated image, artefacts introduced by the source being present in the demodulated image; and
processing the demodulated image using the source impulse response to reduce the artefacts in the demodulated image introduced by the source.

2. The method according to claim 1, wherein the source impulse response and the detector impulse response are determined by capturing at least two further images of energy generated by the source.

3. The method according to claim 1, wherein the source impulse response and the detector impulse response are determined by capturing at least two further images of energy generated by the source, and wherein in a first one of the captured further images the impulse response of the source is dominating over the impulse response of the detector.

4. The method according to claim 1, wherein the source impulse response and the detector impulse response are determined by capturing at least two further images of energy generated by the source, and wherein in a second one of the captured further images the impulse response of the detector is dominating over the impulse response of the source.

5. The method according to claim 2, wherein the source impulse response and the detector impulse response are determined by capturing at least two further images of energy generated by the source, and wherein the two further images are captured without the object being present.

6. The method of claim 1, wherein the source impulse response is determined by positioning a multi-opening device at a position of the grating.

7. The method of claim 1, wherein the source impulse response is determined by positioning a multi-opening device at a position between the grating and the source and moving the multi-opening device towards the source.

8. The method of claim 1, wherein the detector impulse response is determined by positioning a multi-opening device adjacent to the detector and capturing an image produced by X-rays passing through said multi-opening device.

9. The method of claim 1, wherein the demodulated image is determined by applying a non-linear demodulation method.

10. An image processing system comprising:
a memory for storing data and a computer program;
a processor coupled to the memory for executing the computer program, said computer program comprising instructions for:
receiving an impulse response of a source of an interferometer system;
receiving an impulse response of a detector of the interferometer system, the source impulse response being determined independently of the detector impulse response;
capturing an image of an object generated by a grating of the interferometer system, the image being captured by the detector of the interferometer system;
processing the captured image using the determined detector impulse response to attenuate artefacts introduced by the detector;
demodulating the processed image to produce a demodulated image, artefacts introduced by the source being present in the demodulated image; and
processing the demodulated image using the source impulse response to reduce the artefacts in the demodulated image introduced by the source.

11. An image processing apparatus comprising:
receiving module for receiving an impulse response of a source of an interferometer system and for receiving an impulse response of a detector of the interferometer system, the source impulse response being determined independently of the detector impulse response;
capturing module for capturing an image of an object generated by a grating of the interferometer system, the image being captured by the detector of the interferometer system;
processing module for processing the captured image using the determined detector impulse response to attenuate artefacts introduced by the detector;
demodulating module for demodulating the processed image to produce a demodulated image, artefacts introduced by the source being present in the demodulated image; and
processing module for processing the demodulated image using the source impulse response to reduce the artefacts in the demodulated image introduced by the source.

12. A computer readable medium having a computer program recorded thereon for image processing, the program comprising:
code for receiving an impulse response of a source of an interferometer system;
code for receiving an impulse response of a detector of the interferometer system, the source impulse response being determined independently of the detector impulse response;
code for capturing an image of an object generated by a grating of the interferometer system, the image being captured by the detector of the interferometer system;
code for processing the captured image using the determined detector impulse response to attenuate artefacts introduced by the detector;
code for demodulating the processed image to produce a demodulated image, artefacts introduced by the source being present in the demodulated image; and
code for processing the demodulated image using the source impulse response to reduce the artefacts in the demodulated image introduced by the source.

13. A method for processing an image of an object captured by a system, the method comprising:
capturing a first image to determine an impulse response of an energy source of the system, the first image being produced by energy waves from the energy source passing through a first opening device of the system, the first opening device being positioned towards the energy source; and
capturing a second image to determine an impulse response of a detector of the system, the second image being produced by the energy waves passing through a second opening device of the system, the second opening device being positioned towards the detector, wherein the source impulse response and the detector impulse response are determined to be used independently to process the image of the object.

14. The method according to claim 13, wherein the first multi-opening device and the second multi-opening device are pinhole devices.

15. The method according to claim 13, wherein the impulse response of the energy source of the system is determined periodically.

16. A system for processing an image of an object captured, the system comprising:
a memory for storing data and a computer program; and
a processor coupled to the memory for executing the program, the program comprising instructions for:
capturing a first image to determine an impulse response of an energy source of the system, the first image being produced by energy waves from the energy source passing through a first opening device of the system, the first opening device being positioned towards the energy source; and
capturing a second image to determine an impulse response of a detector of the system, the second image being produced by the energy waves passing through a second opening device of the system, the second opening device being positioned towards the detector, wherein the source impulse response and the detector impulse response are determined to be used independently to process the image of the object.

17. An apparatus for processing an image of an object captured by a system, the apparatus comprising:
capturing module for capturing a first image to determine an impulse response of an energy source of the system, the first image being produced by energy waves from the energy source passing through a first opening device of the system, the first opening device being positioned towards the energy source, wherein the capturing module captures a second image to determine an impulse response of a detector of the system, the second image being produced by the energy waves passing through a second opening device of the system, the second opening device being positioned towards the detector; and
processing module for processing the image of the object using the source impulse response and the detector impulse response.

18. A computer readable medium having a computer program stored thereon for processing an image of an object captured by a system, the program comprising:
code for capturing a first image of the object to determine an impulse response of an energy source of the system, the first image being produced by energy waves from the energy source passing through a first opening device of the system, the first opening device being positioned towards the energy source;
code for capturing a second image of the object to determine an impulse response of a detector of the system, the second image being produced by the energy waves passing through a second opening device of the system, the second opening device being positioned towards the detector; and
code for processing the image of the object using the source impulse response and the detector impulse response.

19. A system comprising:
an x-ray source producing a plurality of X-rays;
a source grating forming a plurality of virtual sources as at least a portion of the X-rays pass through openings in the source grating, the source grating being associated with a source impulse response of the system to at least one of the plurality of virtual sources;
a detector adapted to capture an image from the source grating, the captured image being dependent on at least the source impulse response and characteristics of the detector; and
a processor for executing a computer program, the computer program comprising instructions for:
processing the captured image using the characteristics of the detector to attenuate artefacts introduced by the detector;
demodulating the processed image to determine a demodulated image; and
processing the demodulated image using the source impulse response to enhance contrast in the demodulated image.

20. The system of claim 19, further comprising a phase grating adapted to produce a phase contrast moire image, the phase grating being positioned between the source grating and the detector.

21. The system of claim 19, wherein the demodulated image is determined by applying a non-linear demodulation method.

22. The system of claim 19, wherein the source impulse response is determined by positioning a pinhole device at a position of the phase grating.

23. The system of claim 19, further comprising a phase grating adapted to produce a phase contrast moire image, the phase grating being positioned between the source grating and the detector, wherein the source impulse response is determined by positioning a pinhole device at a position between the phase grating and the source and moving the pinhole device towards the source.

24. The system of claim 19, wherein the detector impulse response is determined by positioning a pinhole device adjacent to the detector and capturing an image produced by X-rays passing through said pinhole device.
